(19) United States
(12) Patent Application Publication
(10) Pub. No.: US 2012/0210642 A1
(43) Pub. Date: Aug. 23, 2012

(54) Plant Watering System

(76) Inventor: Eugene Tomas, Coon Rapids, MN (US)

(21) Appl. No.: 13/030,346

(22) Filed: Feb. 18, 2011

(51) Int. Cl. A01G 25/00; A01G 9/02

(52) U.S. Cl. 47/79

(57) ABSTRACT

A plant watering system comprising: at least two planters; at least two pots in each planter; and a PVC pipe that extends from each side of a ball-cock, where the PVC pipe-ball-cock connection connects the at least two planters and water flows through the ball-cock and the PVC pipes and enters into the planters to supply water for the at least two pots. The ball-cock activates the flow of water into the planters upon a diminished level of water. Each planter may include a relief hole set at a predetermined level and a means to connect an additional PVC pipe-ball-cock connection.

### BACKGROUND OF THE INVENTION

1. Field of Invention

The present invention relates to an automated plant watering system to facilitate the watering of several plants simultaneously.

2. Description of Related Art

Every gardener realizes the importance of watering plants as a necessity of the caretaking of plants. Whether indoor or outdoor, plants need water for survival. In certain environments or instances, some gardeners have used the automatic watering systems to facilitate the watering of a group of plants. Some of these watering systems spray water over a field of plants or transport water to the pots that may enclose the plants. In either situation it is important that water is delivered in a timely and periodic matter to ensure the health of the plants.

Some examples of some plant watering systems have been described and disclosed in the prior art such as U.S. Pat. No. 6,112,456 that discloses a plant watering system for feeding the group systems of plants in soil in a time-release manner for a period of time which includes a tapered conical watering spike that has radially extending blades for stabilizing the spike in the soil. Another example of a plant watering system is described in U.S. Pat. No. 6,845,588 that discloses a method and apparatus for automatically watering plants where water is fed from a supply source to a control valve or multiple valves that regulate the amount of water supplied to each individual plant. Although some developments have been created within the prior art further plant-watering systems are necessary to meet the needs of the gardener.

### SUMMARY OF THE INVENTION

The present invention relates to a plant watering system comprising: at least two planters; at least two pots in each planter; and a PVC pipe that extends from each side of a ball-cock, where the PVC pipe-ball-cock connection connects the at least two planters and water flows through the ball-cock and the PVC pipes and enters into the planters to supply water for the at least two pots. The ball-cock activates the flow of water into the planters upon a diminished level of water. Each planter may include a relief hole set at a predetermined level and a means to connect an additional PVC pipe-ball-cock connection. In one particular embodiment, the means to connect includes a punch out hole that all

### BRIEF DESCRIPTION OF DRAWINGS

FIG. 1 depicts a plant watering system according to the present invention.

### DETAILED DESCRIPTION

The present invention relates to a plant watering system that enables the automatic watering of a plurality of potted plants. The watering system includes a series of planters that enclose at least two plant pots. The planters are connected to a flow of water that is activated through a ball-cock system connected to the planter. The ball-cock operates such that once the ball sinks to a certain level a flow of water is supplied within the planter and therefore provides water for the pots that are sitting within the planter. The system is unique in that a number of planters may be interconnected through a series of PVC pipes that include a ball-cock connected between the planters. Therefore, the planters receive water based upon the condition of the ball-cock.

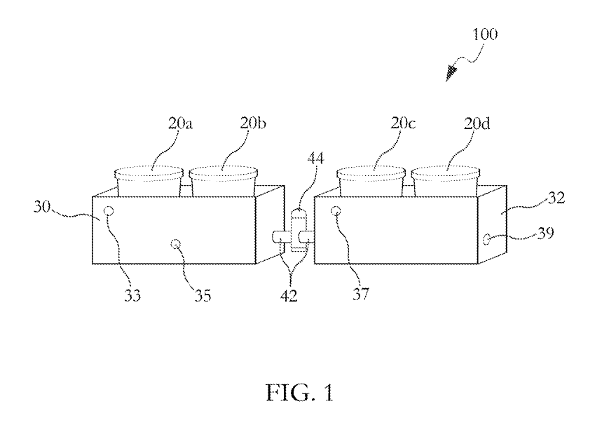

FIG. 1 depicts a Plant Watering System 100 according to the present invention. The plant watering system as depicted in FIG. 1 includes two planters, a Planter 32 and a Planter 30. Planter 30 includes Pots 20a, 20b. Planter 32 includes Pot 20c and Pot 20d. The planters 30, 32 are connected through the use of a PVC Pipe 42 that extends from each side of a Ball-cock 44. Water flows through the ball-cock container 44, where a ball-cock not shown floats within the container 44. PVC pipes 42 extend out of the container 44 and enter into the planters 30, 32 to supply water for the pot supply. Upon a diminished level of water, the ball-cock container 44 activates the flow of water into the planters 30, 32.

Relief holes, Relief Hole 33 on Planter 30 and Relief Hole 37 on Planter 32 provide a means to release water that may cause the planters to overflow. The relief holes are particularly useful where the planters are located outside and may receive rainwater from the outdoor environment. The relief holes allow for the flow of water outside of the planters at a predetermined level. The relief holes prevent the planters from overflowing in a rainy condition. Further provided are Punch-out Holes 35 on Planter 30 and Punch-out Hole 39 on Planter 32. The punch-out holes allow for the attachment of further PVC connections to increase the number of interconnected planters. Consequently although shown as a two-planter system multiple planters may be interconnected through the use of the PVC pipe and ball-cock connections as shown in FIG. 1. The plant watering system according to the present invention consequently allows for the automatic watering of a number of potted plants that reside within a planter as shown and described above. The system may grow to several planters and pots within the planters. The only limitations that may occur in such a system would be insuring that adequate water supply is available for the number of planters and pots being watered. The instant invention has been shown and described in what it considers to be the most practical and preferred embodiments. It is recognized, however, that departures may be made there from within the scope of the invention and that obvious modifications will occur to a person skilled in the art.

1. A plant watering system comprising:
a. at least two planters;
b. at least two pots in each planter; and
c. a PVC pipe that extends from each of the at least two planters and are connected at a ball-cock, where the PVC pipes-ball-cock connection connects the at least two planters, where water flows through the ball-cock and the PVC pipes and enters into the planters to supply water for the at least two pots, and where upon a diminished level of water the ball-cock activates the water flow through the ball-cock and PVC pipes into the planters.

2. (canceled)

3. The plant watering system according to claim 1, wherein each planter includes a relief hole set at a predetermined level.

4. The plant watering system according to claim 1, wherein each planter includes a means to connect an additional PVC pipe-ball-cock connection.

5. A plant watering system according to claim 4, wherein the means to connect includes a punch out hole.

6. A plant watering system according to claim 5, wherein the punch out hole allows for an additional PVC pipe-ball-cock connections to an additional planter.
